(19) United States
(12) Patent Application Publication
(10) Pub. No.: US 2006/0244987 A1
(43) Pub. Date: Nov. 2, 2006

(54) Apparatus and program activation method

(76) Inventor: Kiwamu Okabe, Kanagawa (JP)

Correspondence Address: C. IRVIN MCCLELLAND;OBLON, SPIVAK, MCCLELLAND, MAIER & NEUSTADT, P.C., 1940 DUKE STREET, ALEXANDRIA, VA, 22314, US

(21) Appl. No.: 11/402,844

(22) Filed: Apr. 13, 2006

(30) Foreign Application Priority Data
Apr. 27, 2005 (JP) 2005-130284

(51) Int. Cl. G06F 3/12

(52) U.S. Cl. 358/1.13; 358/1.15

(57) ABSTRACT

An apparatus capable of activating a program recorded in an external medium for distributing the program is disclosed. The apparatus includes an identity determination part configured to determine whether the program recorded in the external medium and a program stored in a recording medium in the apparatus are identical based on first identification information for uniquely identifying the program recorded in the external medium and second identification information for uniquely identifying the program stored in the recording medium in the apparatus; and a program activation part configured to activate the program stored in the recording medium in the apparatus if the identity determination part determines that the programs are identical.

### BACKGROUND OF THE INVENTION

1. Field of the Invention

The present invention relates generally to apparatuses and program activation methods, and more particularly to an apparatus capable of activating a program recorded in an external medium for distributing the program and a method of activating the program in the apparatus.

2. Description of the Related Art

In so-called multifunction peripherals (MFPs), that are multifunction machines achieving functions such as copying, facsimile (FAX), printing, and scanning in a single housing, a CPU processes various programs, thereby executing the functions. In these years, some multifunction machines are capable of executing not only applications already installed therein at the time of shipment but also applications provided by portable recording media such as an SD (secure digital) card. In such multifunction machines, users are enabled to enhance functions after starting to use them. Providing applications through SD cards improves the expandability of multifunction machines, thus making it possible to increase their serviceability. Further, the SD card has the merit of better hardware reliability (lower probability of hardware damage) than the HDD (Hard Disk Drive).

FIG. 1 is a block diagram for illustrating a program arrangement in a conventional multifunction machine 500. Referring to FIG. 1, a CPU 501, a chipset 502, a RAM 503, a ROM 504, and an HDD 505 are components housed in the multifunction machine 500. Further, an SD card 506 is inserted into an SD card slot of the multifunction machine 500 when used. Basic programs such as an OS (operating system) 511 are recorded in the ROM 504. Application programs such as a copying program 512, a facsimile program 513, and a printing program 514 are recorded in the SD card 506. Accordingly, the CPU 501 performs the functions of the multifunction machine 500 by executing the applications recorded in the SD card 506 on the basic programs 511 recorded in the ROM 504. The HDD 505 is used principally as an area for storing image data scanned by the multifunction machine 500.

An overview is given of a start-time operation in the multifunction machine 500 of FIG. 1. FIG. 2 is a sequence diagram for giving an overview of the start-time operation of the multifunction machine 500. FIG. 2 is based on the assumption that the basic programs 511 have already been read into memory and activated.

First, in step S101, the basic programs 501 check the HDD 505 for software damage, and in step S102, the basic programs 501 check the SD card 506 for software damage. This software damage check in steps S101 and S102 is the operation of determining whether the HDD 505 and the SD card 506 are usable. For example, it is determined whether an operation that may cause software damage, such as turning off power abruptly, was performed at the time of previous use, and if such an operation has been performed, the recording medium is scanned and checked for software damage.

When the software damage check of the SD card 506 is completed in step S103, in step S104, the basic programs 511 access the SD card 506, and in step S105, read the copying program 512 therefrom into memory. Then, in step 106, the basic programs 511 activate the copying program 512. Likewise, in steps S107 through S112, the basic programs 511 read the facsimile program 513 and the printing program 514 from the SD card 506 into the memory, and activate the facsimile program 513 and the printing program 514.

The activity diagram of the above-described operation is as shown in FIG. 3. FIG. 3 is an activity diagram for illustrating the start-time operation in the multifunction machine 500.

First, in step S151, the basic programs 511 are activated. Next, the basic programs 511 check the HDD 505 (in step 152) and the SD card 506 (in step S153) in parallel for software damage.

When finishing at least the damage check of the SD card 506, in step S154, the basic programs 511 read an application from the SD card 506 into memory, and in step S155, activate the application. In step S156, the basic programs 511 repeat this reading and activation until all the applications are read from the SD card 506 into the memory and activated. In step S157, when all the applications have been activated, the functions of the multifunction machine 500, such as copying, facsimile, and printing, are available to a user.

However, the SD card has the disadvantage of being inferior to the HDD in reading rate. Accordingly, the operation of reading various applications from the SD card 506 at the time of starting the multifunction machine 500 causes the problem of an increase in the start time of the multifunction machine 500.

### SUMMARY OF THE INVENTION

According to one embodiment of the present invention, there is provided an apparatus and a program activation method in which the above-described disadvantage is eliminated.

According to one embodiment of the present invention, there is provided an apparatus and a program activation method that are capable of reducing time for activating an application program recorded in an external recording medium.

According to one embodiment of the present invention, there is provided an apparatus capable of activating a program recorded in an external medium for distributing the program, the apparatus including: an identity determination part configured to determine whether the program recorded in the external medium and a program stored in a recording medium in the apparatus are identical based on first identification information for uniquely identifying the program recorded in the external medium and second identification information for uniquely identifying the program stored in the recording medium in the apparatus; and a program activation part configured to activate the program stored in the recording medium in the apparatus if the identity determination part determines that the programs are identical.

According to this apparatus, there is no need to read an application program from an external medium. Accordingly, it is possible to reduce the time required for activating the application program recorded in the external medium.

According to one embodiment of the present invention, there is provided a program activation method in an apparatus capable of activating a program recorded in an external medium for distributing the program, the program activation method including the steps of: (a) determining whether the program recorded in the external medium and a program stored in a recording medium in the apparatus are identical based on first identification information for uniquely identifying the program recorded in the external medium and second identification information for uniquely identifying the program stored in the recording medium in the apparatus; and (b) activating the program stored in the recording medium in the apparatus if step (a) determines that the programs are identical.

Thus, according to the present invention, it is possible to provide an apparatus and a program activation method capable of reducing the time required for activating an application program recorded in an external medium.

### BRIEF DESCRIPTION OF THE DRAWINGS

Other objects, features and advantages of the present invention will become more apparent from the following detailed description when read in conjunction with the accompanying drawings, in which:

FIG. 1 is a block diagram for illustrating a program arrangement in a conventional multifunction machine;

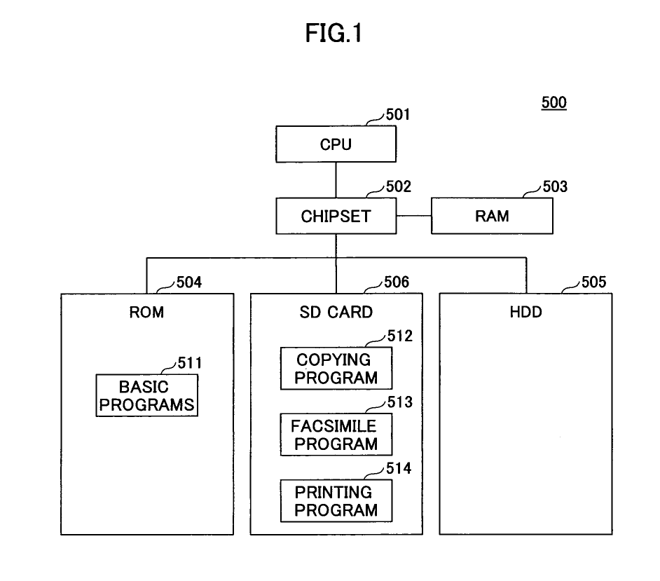

FIG. 2 is a sequence diagram for giving an overview of a start-time operation in the conventional multifunction machine;

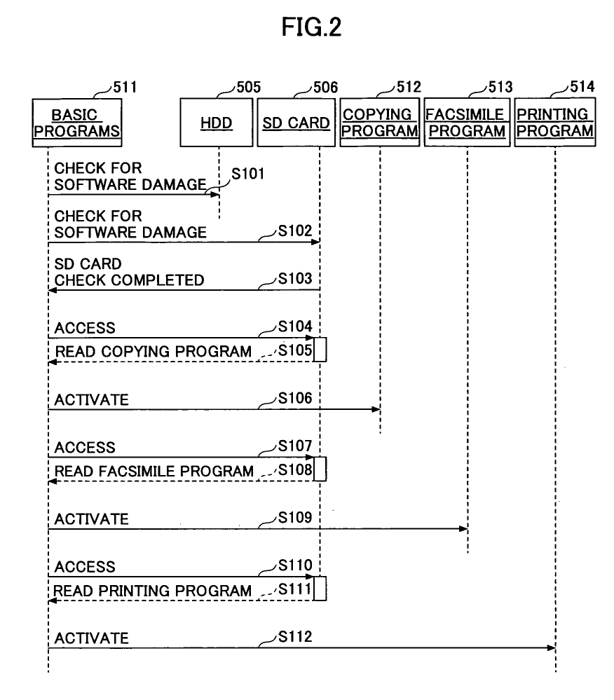

FIG. 3 is an activity diagram for illustrating the start-time operation in the conventional multifunction machine;

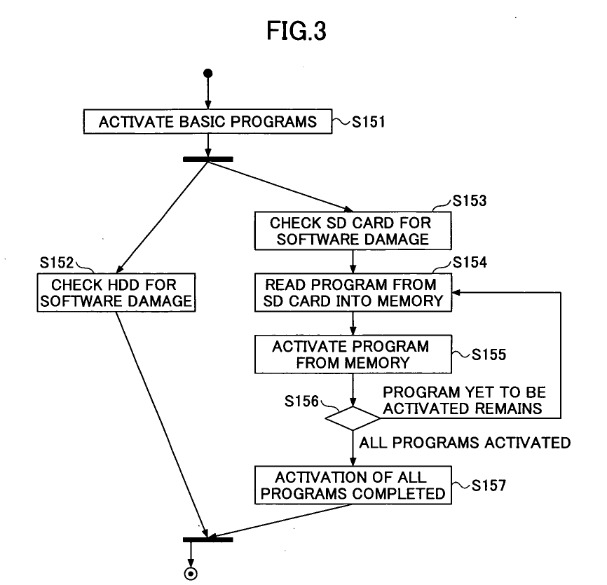

FIG. 4 is a block diagram showing a multifunction machine according to a first embodiment of the present invention;

FIG. 5 is a diagram for illustrating a method of generating the electronic signature of an application program according to the first embodiment of the present invention;

FIG. 6 is a sequence diagram for giving an overview of a start-time operation in the multifunction machine according to the first embodiment of the present invention;

FIG. 7 is a diagram conceptually showing a method of determining whether application programs in an SD card and an HDD are identical according to the first embodiment of the present invention;

FIG. 8 is an activity diagram for illustrating the start-time operation in the multifunction machine according to the first embodiment of the present invention;

FIG. 9 is a concept diagram for illustrating a method of authenticating an application program according to the first embodiment of the present invention;

FIG. 10 is a sequence diagram for giving an overview of a start-time operation in the multifunction machine according to a second embodiment of the present invention; and

FIG. 11 is an activity diagram for illustrating the start-time operation in the multifunction machine according to the second embodiment of the present invention.

### DETAILED DESCRIPTION OF THE PREFERRED EMBODIMENTS

A description is given, with reference to accompanying drawings, of embodiments of the present invention.

First Embodiment

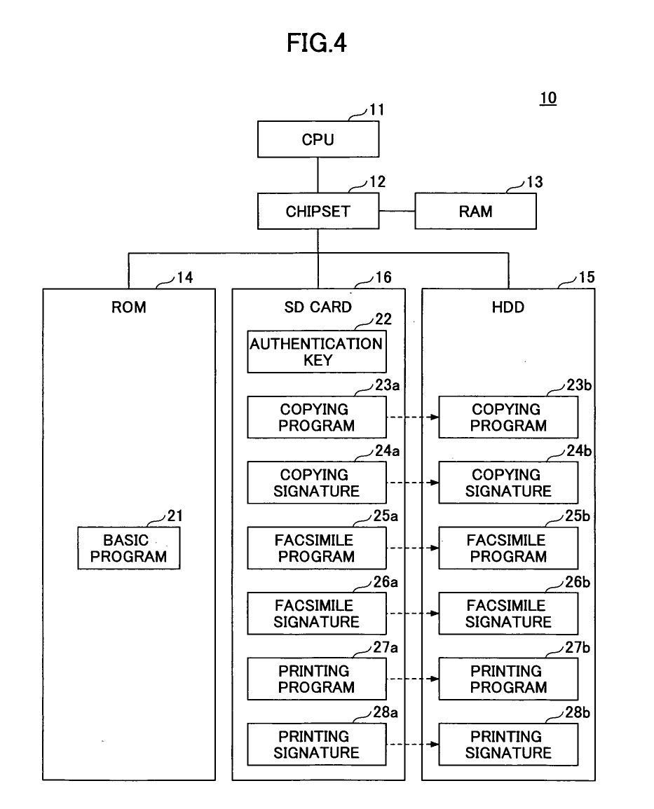

FIG. 4 is a block diagram showing a multifunction machine 10 according to a first embodiment of the present invention. Referring to FIG. 4, the multifunction machine 10, which is an apparatus according to one embodiment of the present invention, includes a CPU 11, a chipset 12, a RAM 13, a ROM 14, and an HDD 15. The multifunction machine 10 includes an SD card slot (not graphically illustrated), into which an SD card 16 is inserted.

The CPU 11 achieves functions according to the multifunction machine 10 by executing the programs recorded in the ROM 14, the HDD 15, and the SD card 16. The chipset 12 connects the CPU 11 and the RAM 13 to each other and controls their operations. The RAM 13 is used principally as a work memory area in the case of program execution by the CPU 11.

A basic program 21 is prerecorded in the ROM 14. The basic program 21 corresponds to an OS. As an internal recording medium of the multifunction machine 10, the HDD 15 is used for storing image data scanned by the multifunction machine 10. Further, according to this embodiment, the HDD 15 is also used as a cache storage area for the programs recorded in the SD card 16.

The SD card 16 is an external medium for distributing (providing) programs to the multifunction machine 10. As objects of distribution, an authentication key 22, a copying program 23a, a copying signature 24a, a facsimile program 25a, a facsimile signature 26a, a printing program 27a, and a printing signature 28a are recorded in the SD card 16.

The copying program 23a, the facsimile program 25a, and the printing program 27a are application programs for a copying function, a facsimile function, and a printing function, respectively, in the multifunction machine 10. That is, the functions of the multifunction machine 10 can be enhanced by executing not only programs installed in the ROM 14 at the time of factory shipment but also programs provided by the SD card 16. Accordingly, it is also possible to further expand the functions of the multifunction machine 10 using another SD card on which an application different from those recorded in the SD card 16 is recorded. In general, the SD card has higher hardware reliability than the HDD. In this respect, distribution of applications through the SD card has merit.

In addition, the copying signature 24a, the facsimile signature 26a, and the printing signature 28a are recorded in the SD card 16. The copying signature 24a is the electronic signature of the copying program 23a. The facsimile signature 26a is the electronic signature of the facsimile program 25a. The printing signature 28a is the electronic signature of the printing program 27a. Each electronic signature is used as information for uniquely identifying the corresponding application program and information for verifying that the corresponding application program has not been tampered with.

That is, the SD card 16 has the characteristic of being easily readable and writable by other computers, but this characteristic makes it vulnerable to information falsification. Therefore, by correlating each application program with the corresponding electronic signature, the multifunction machine 10 can detect falsification of an application program and prevent improper activation of an application program infected with a virus or the like.

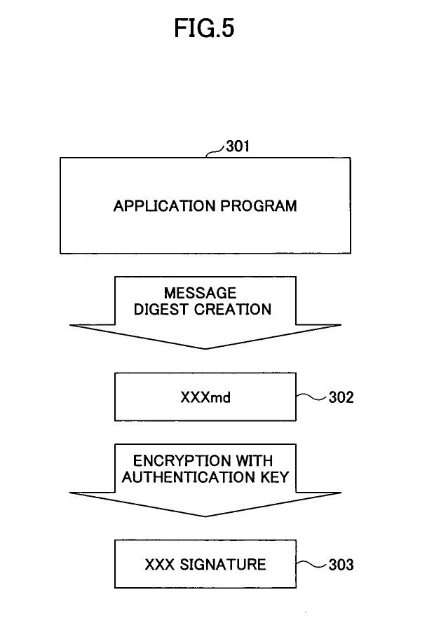

FIG. 5 is a diagram for illustrating a method of generating the electronic signature of an application program according to this embodiment. Referring to FIG. 5, first, a message digest 302 of an application program 301 is generated by applying a predetermined message digest function to the application program 301. Next, the message digest 302 is encrypted with the authentication key 22, so that an electronic signature 303 is generated.

That is, the copying signature 24a is the message digest of the copying program 23a encrypted with the authentication key 22. Likewise, the facsimile signature 26a is the message digest of the facsimile program 25a encrypted with the authentication key 22, and the printing signature 28a is the message digest of the printing program 27a encrypted with the authentication key 22. The method of detecting falsification of each application program is described below.

Referring back to FIG. 4, a copying program 23b, a copying signature 24b, a facsimile program 25b, a facsimile signature 26b, a printing program 27b, and a printing signature 28b are recorded in the HDD 15. These are copies of the corresponding application programs and electronic signatures recorded in the SD card 16. As is described below, the application programs and electronic signatures are copied at least when the applications are activated from the SD card 16. That is, these application programs and electronic signatures are not recorded in the HDD before the application programs are put to use using the SD card 16.

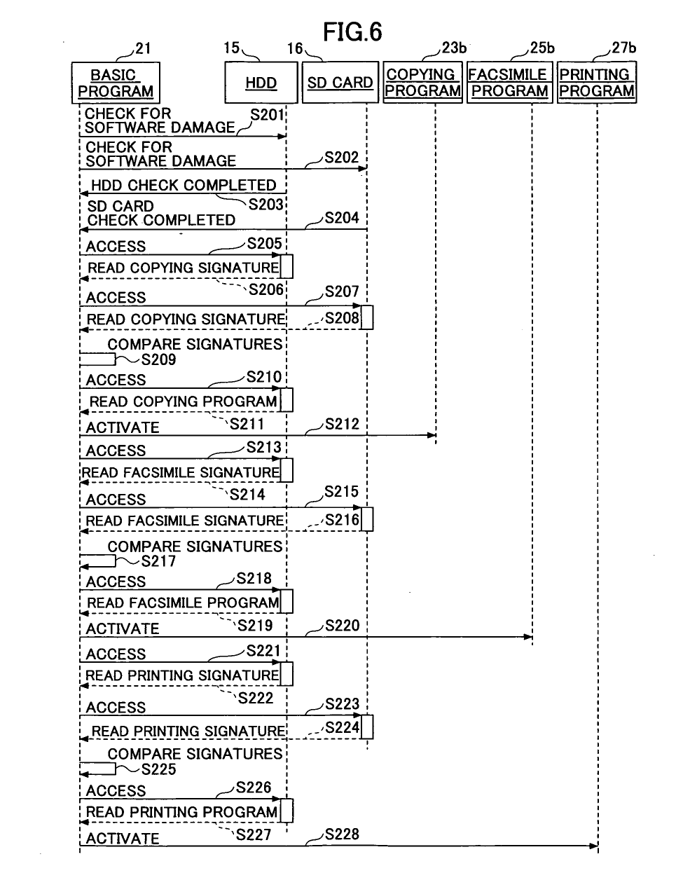

A description is given below of an operating procedure of the multifunction machine 10 of FIG. 4. FIG. 6 is a sequence diagram for giving an overview of a start-time operation in the multifunction machine 10 according to the first embodiment. FIG. 6 is based on the assumption that each application program and its electronic signature have already been copied from the SD card 16 to the HDD 15.

First, in step S201, the basic program 21 checks the HDD 15 for software damage, and in step S202, the basic program 21 checks the SD card 16 for software damage. This software damage check in steps S201 and S202 is the operation of determining whether the HDD 15 and the SD card 16 are usable. For example, it is determined whether an operation that may cause software damage, such as turning off power abruptly, has been performed at the time of previous use, and if such an operation has been performed, the recording medium is scanned and checked for software damage.

When the basic program 21 completes the software damage check of both the HDD 15 and the SD card 16 so that both the HDD 15 and the SD card 16 are accessible, the basic program 21 accesses the HDD 15 (step S205) and reads the copying signature 24b therefrom into memory (step S206), and accesses the SD card 16 (step S207) and reads the copying signature 24a therefrom into the memory (step S208). Then, in step S209, the basic program 21 compares the values of the copying signature 24a and the copying signature 24b read into the memory, thereby determining whether the copying program 23a and the copying program 23b are identical. The basic program 21 confirms their identity (identicalness), that is, determines that the copying program 23a and the copying program 23b are identical, if the value of the copying signature 24a and the value of the copying signature 24b are the same.

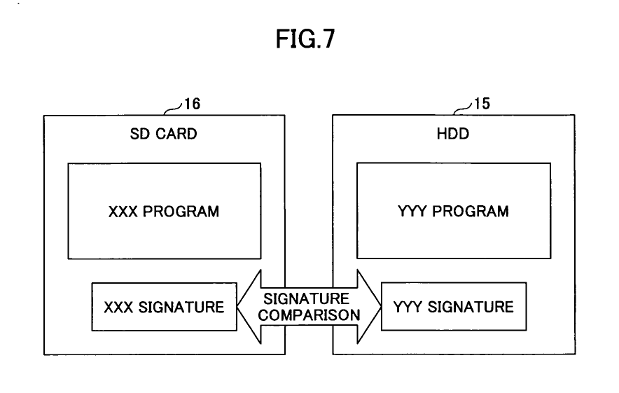

FIG. 7 is a diagram conceptually showing a method of determining whether application programs in the SD card 16 and the HDD 15 are identical according to this embodiment. FIG. 7 shows the case of determining whether an XXX program and a YYY program are identical by comparing the values of an XXX signature and a YYY signature, which are their respective signatures.

When it is confirmed that the copying program 23a and the copying program 23b are identical, the basic program 21 accesses the HDD 15 (step S210) and reads the copying program 23b therefrom into the memory (step S211). Then, in step S212, the basic program 21 activates the copying program 23b read into the memory in place of the copying program 23a in the SD card 16. That is, if the copying program 23a and the copying program 23b are identical, the copying program 23b recorded in the HDD 15 enjoying a high reading rate is used, thereby reducing time required for reading the copying program.

Thereafter, in steps S213 through S228, the basic program 21 compares the values of electronic signatures in the SD card 16 and the HDD 15 with respect to each of the facsimile program 25a and the printing program 27a, and if the values are identical to each other, the basic program 21 activates the facsimile program 25b and the printing program 27b in the HDD 15.

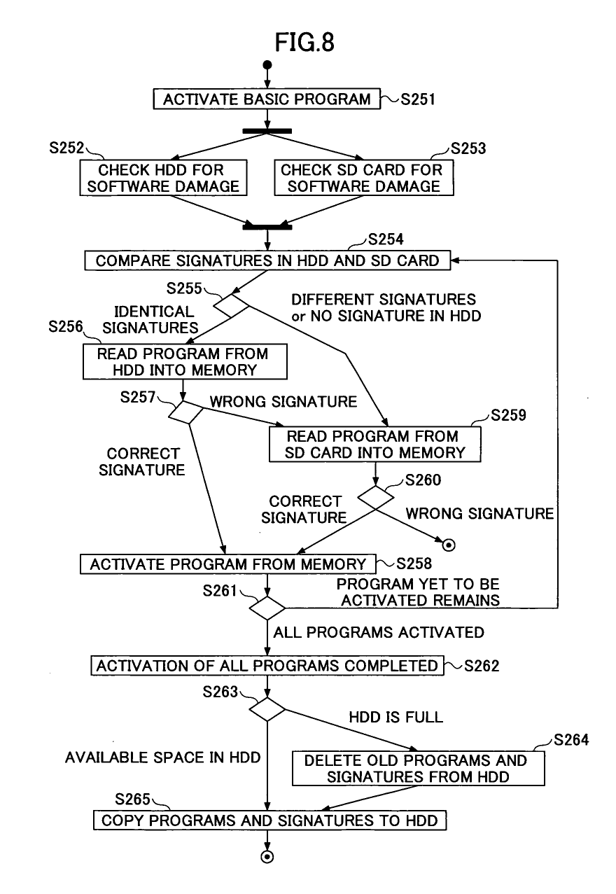

The activity diagram of the operation of FIG. 6 is as shown in FIG. 8. FIG. 8 is an activity diagram for illustrating the start-time operation in the multifunction machine 10 according to the first embodiment.

First, in step S251, the basic program 21 is activated. Then, the basic program 21 checks the HDD 15 (in step S251) and the SD card 16 (in step S253) in parallel for software damage.

When the software damage check of each of the HDD 15 and the SD card 16 is completed, in step S254, the basic program 21 reads an electronic signature for an application program (hereinafter referred to as “current application”) from each of the HDD 15 and the SD card 16 into memory, and compares the values of the two electronic signatures (for example, the copying signature 24b and the copying signature 24a).

Next, in step S255, the basic program 21 determines whether the values of the two electronic signatures are the same. If the values are the same, in step S256, the basic program 21 reads the current application from the HDD 15 into the memory. Then, in step S257, the basic program 21 authenticates the current application based on the electronic signature of the current application already read into the memory. Here, authenticating an application program refers to verifying that the application program is not tampered with.

That is, it is presumed after a fashion that the current application in the HDD 15 and the current application in the SD card 16 are identical. However, for example, the original current application in the SD card 16 may be tampered with, or the current application in the HDD 15 may be falsified after the current application is copied to the HDD 15. Accordingly, in terms of security, it is preferable to verify that the current application which has been read from the HDD 15 and is going to be activated is not tampered with before its activation.

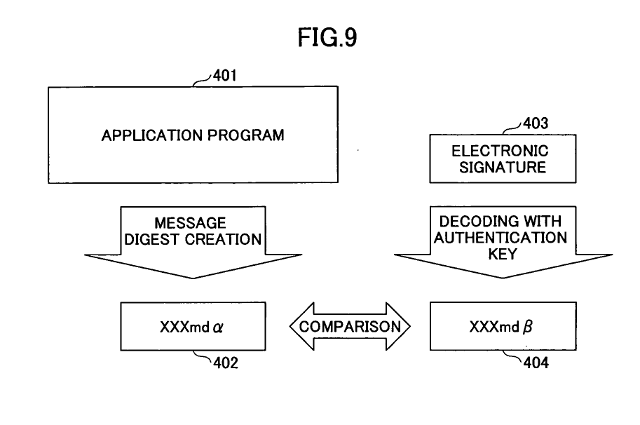

FIG. 9 is a concept diagram for illustrating a method of authenticating an application program according to this embodiment. FIG. 9 shows the case of authenticating an application program 401. In this case, a message digest function is applied to the application program 401, thereby generating a message digest 402. On the other hand, an electronic signature 403 of the application program 401 is decoded using the authentication key 22, thereby generating decoded data 404. Then, the message digest 402 and the decoded data 404 are compared, and if they are identical, the application program 401 is authenticated.

Accordingly, in step S257, the basic program 21 authenticates the current application by generating the message digest of the current application, decoding the electronic signature of the current application already read into the memory using the authentication key 22, and comparing the message digest and the decoded electronic signature. A description of authentication of the application program is omitted in FIG. 6 for convenience.

When the current application is authenticated, in step S258, the basic program 21 activates the current application read from the HDD 15 into the memory.

On the other hand, if the two electronic signatures do not match or there is no corresponding electronic signature in the HDD 15 in step S255, or if the current application is not authenticated in step S257, in step S259, the basic program 21 reads the current application from the SD card 16 into the memory. If the application program has not been activated from the SD card 16 in the past, a copying operation in below-described step S265 has not been performed. Accordingly, the application program and its electronic signature are not recorded in the HDD 15. Therefore, in this case, it is determined in step S255 that there is no corresponding electronic signature in the HDD 15.

Next, in step S260, the basic program 21 performs an authentication operation on the current application read from the SD card 16. That is, the basic program 21 generates the message digest of the current application, decodes the electronic signature of the current application already read into the memory using the authentication key, and compares the message digest and the decoded electronic signature. If the current application is authenticated, in step S258, the basic program 21 activates the current application read from the SD card 16. If the current application is not authenticated, the basic program 21 stops the operation.

The operation from step S254 to step S258 is performed with respect to all the other application programs recorded in the SD card 16 (step S261).

When all the application programs are activated in step S262, in step S263, the basic program 21 checks the HDD 15 for available storage capacity, and determines whether there is an area for recording all the application programs and their electronic signatures recorded in the SD card 16 (hereinafter referred to as “copying area”) remaining in the HDD 15. If there is a copying area in the HDD 15, in step S265, the basic program 21 copies all the application programs and their electronic signatures recorded in the SD card 16 into the HDD 15. If there is no copying area in the HDD 15, in step S264, the basic program 21 deletes application programs, etc., copied into the HDD 15 from SD cards in the past in chronological order, and after reserving a copying area, in step S265, the basic program 21 performs copying. Accordingly, next time the multifunction machine 10 is started, basically, the application programs copied into the HDD 15 are activated.

In step S265, the authentication key 22 is not copied in order to prevent a dead copy of the SD card 16 from being made. That is, even if another SD card is created by making a copy of the HDD 15, the authentication key 22 is not included in the other SD card. Accordingly, even if an attempt is made to activate the multifunction machine 10 by inserting the other SD card into the multifunction machine 10, authentication of the application programs fails because of absence of the authentication key 22 in the other SD card, and thus the multifunction machine 10 cannot be started.

That is, even when all the application programs in the SD card 16 are copied into the HDD 15, the copied application programs are enabled (usable) only when the SD card 16 from which the application programs are copied is inserted into the multifunction machine 10. This prevents a dead copy of the SD card 16 from being made.

As described above, according to the multifunction machine 10 according to the first embodiment, the applications in the SD card 16 are virtually activated using applications from the HDD 15 enjoying a higher reading rate than the SD card 16. Therefore, it is possible to reduce the operating time for activating the applications in the SD card 16, thus making it possible to reduce the operating time for starting the multifunction machine 10.

Although the SD card 16 is accessed for determining the identity (identicalness) of application programs, it is the electronic signature of the corresponding application program having less information than the application program that is read from the SD card 16 at the time of the access. Therefore, it is possible to reduce the adverse effect of this operation on performance.

The information for uniquely identifying an application program employed in determining the identity (identicalness) of the application program with another application program does not always have to be an electronic signature. Any information will do if the information at least can uniquely identify the application program and has less information than the application program. For example, information such as the message digest of the application program or a combination of the name and version number of the application program may be suitably selected in accordance with operations.

Second Embodiment

Reading an application program from the HDD 15 should be started after completion of the software damage check of the HDD 15. Accordingly, in the first embodiment, the basic program 21 waits for completion of the software damage check of not only the SD card 16 but also the HDD 15 before starting the subsequent operation. In some cases, however, the software damage check of the HDD 15 requires tens of seconds or more because of the size of the storage capacity of the HDD 15. For example, this occurs in the case where an operation that may cause software damage, such as turning off power abruptly, has been performed at the time of previous use. In such a case, waiting for completion of the software damage check of the HDD 15 results in overhead greater than or equal to the reduction in time due to reading application programs from the HDD 15, thus having the opposite effect of increasing the time required for starting the multifunction machine 10. Therefore, as a second embodiment, a description is given of the case where the time required for starting the multifunction machine 10 is prevented from being unnecessarily long even if the software damage check of the HDD 15 requires a long period of time. In the second embodiment, the multifunction machine 10 may have the same configuration as in the first embodiment.

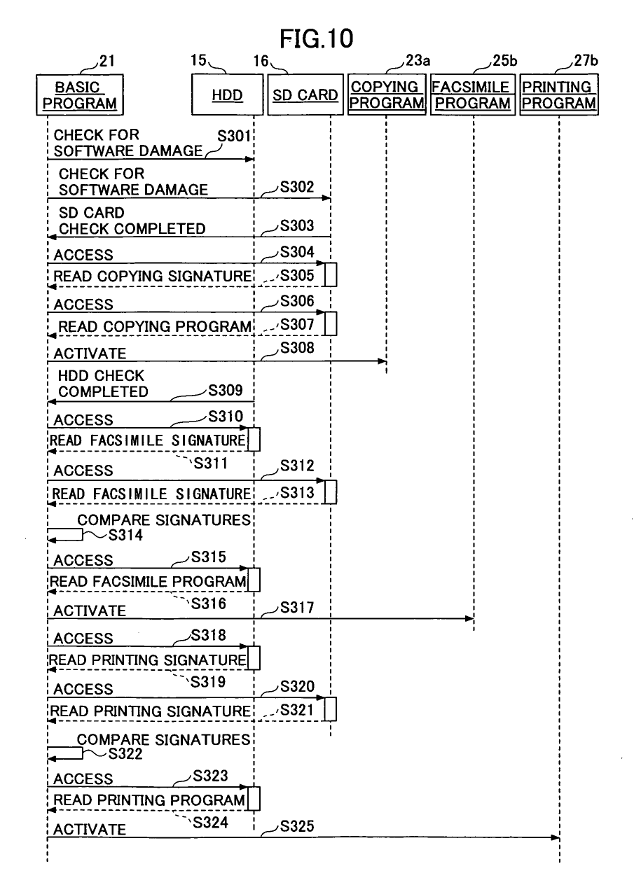

FIG. 10 is a sequence diagram for giving an overview of a start-time operation in the multifunction machine 10 according to the second embodiment. FIG. 10 is also based on the assumption that that each application program and its electronic signature have already been copied from the SD card 16 to the HDD 15.

First, the basic program 21 checks the HDD 15 (in step S301) and the SD card 16 (in step S302) for software damage. When finishing the software damage check of the SD card 16 in step S303, the basic program 21 starts to activate applications without waiting for completion of the software damage check of the HDD 15.

That is, in step S304, the basic program 21 accesses the SD card 16, and in step S305, reads the copying signature 24a therefrom into memory. In step S306, the basic program 21 accesses the SD card 16, and in step S307, reads the copying program 23a therefrom into the memory. Then, in step S308, the basic program 21 activates the copying program 23a read from the SD card 16. Before activating the copying program 23a, the copying program 23a is authenticated, which is omitted in FIG. 10 for convenience.

It is assumed that in step S309, the software damage check of the HDD 15 is completed when activation of the copying program 23a is completed.

Then, the basic program 21 starts to use the HDD 15. That is, in step S310, the basic program 21 accesses the HDD 15, and in step S311, reads the facsimile signature 26b therefrom into the memory. In step S312, the basic program 21 accesses the SD card 16, and in step S313, reads the facsimile signature 26a therefrom into the memory. Then, in step S314, the basic program 21 compares the values of the facsimile signature 26a and the facsimile signature 26b read into the memory, thereby determining whether the facsimile program 25a and the facsimile program 25b are identical.

When the identity (identicalness) of the facsimile program 25a and the facsimile program 25b is confirmed, in steps S315, the basic program 21 accesses the HDD 15, and in step S316, reads the facsimile program 25b therefrom into the memory. Then, in step S317, the basic program 21 activates the facsimile program 25b.

Thereafter, in steps S318 through S325, the basic program 21 also compares the values of the electronic signatures in the SD card 16 and the HDD 15 with respect to the printing program 27a, and if the electronic signatures are identical, the basic program 21 activates the printing program 27b in the HDD 15.

That is, according to the operation of FIG. 10, an application program is activated from the SD card 16 while the HDD 15 is not ready for use. Therefore, it is possible to prevent the time required before the HDD 15 becomes ready for use from directly affecting the time required for starting the multifunction machine 10. Accordingly, even if the time required before the HDD 15 becomes ready for use increases because of delay in the software damage check of the HDD 15, it is possible to prevent the time required for starting the multifunction machine 10 from being unnecessarily long.

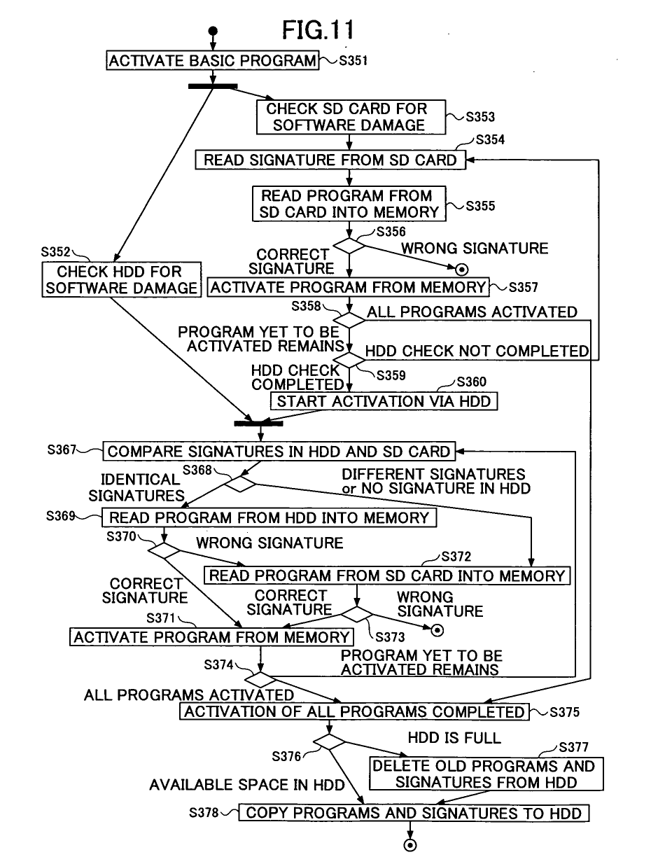

The activity diagram of the operation of FIG. 10 is as shown in FIG. 11. FIG. 11 is an activity diagram for illustrating the start-time operation in the multifunction machine 10 according to the second embodiment.

First, in step S351, the basic program 21 is activated. Then, the basic program 21 checks the HDD 15 (in step S352) and the SD card 16 (in step S353) in parallel for software damage.

When finishing at least the damage check of the SD card 16, in step S354, the basic program 21 determines one of the application programs in the SD card 16 as an application program to be processed, and reads the electronic signature of the determined one of the application programs (hereinafter referred to as “current application”) from the SD card 16 into memory. Then, in step S355, the basic program 21 reads the current application from the SD card 16 into the memory, and in step S356, authenticates the current application using its electronic signature. In the case of failing in authenticating the current application, the basic program 21 stops the operation. When the current application is authenticated, in step S357, the basic program 21 activates the current application read from the SD card 16.

Next, in step S358, the basic program 21 determines whether all the application programs recorded in the SD card 16 have been activated. If all the application programs have been activated, the basic program 21 proceeds to step S375, and copies the application programs and their electronic signatures from the SD card 16 to the HDD 15 in the subsequent steps.

If there remains an application program that has yet to be activated, in step S359, the basic program 21 determines whether the software damage check of the HDD 15 is completed. If the software damage check of the HDD 15 is not completed, the basic program 21 determines the application program that has yet to be activated as an application program to be processed, and repeats the above-described operations after step S353.

If the software damage check of the HDD 15 is completed, in step S360, the basic program 21 starts to activate application programs from the HDD 15. That is, the basic program 21 performs the operations in step S367 and the subsequent steps on each application program that has yet to be activated. The operations in step S367 and the subsequent steps are equal to those in step S254 and the subsequent steps described in FIG. 8, and accordingly, a description thereof is omitted.

As described above, according to the multifunction machine 10 according to the second embodiment, even if the HDD 15 is not accessible for a long period of time, it is possible to prevent the time required for starting the multifunction machine 10 from being unnecessarily long by activating an application program from the SD card 16.

In the above description, the SD card is cited as an external medium for distributing a program. However, such an external medium may be replaced by other recording media such as a CD-ROM. Further, the multifunction machine is cited as an apparatus capable of activating a program recorded in an external medium for distributing the program. However, such an apparatus is not limited to the multifunction machine, and may be an apparatus specialized in a single function, such as a copier, a printer, a scanner, or a facsimile machine. Further, the present invention is applicable to not only apparatuses related to image processing but also various apparatuses as long as the apparatuses are capable of executing an application.

Thus, according to one embodiment of the present invention, there is no need to read an application program from an external medium. Accordingly, it is possible to reduce the time required for activating the application program recorded in the external medium.

The present invention is not limited to the specifically disclosed embodiments, and variations and modifications may be made without departing from the scope of the present invention.

The present application is based on Japanese Priority Patent Application No. 2005-130284, filed on Apr. 27, 2005, the entire contents of which are hereby incorporated by reference.

What is claimed is:

1. An apparatus capable of activating a program recorded in an external medium for distributing the program, the apparatus comprising:
an identity determination part configured to determine whether the program recorded in the external medium and a program stored in a recording medium in the apparatus are identical based on first identification information for uniquely identifying the program recorded in the external medium and second identification information for uniquely identifying the program stored in the recording medium in the apparatus; and
a program activation part configured to activate the program stored in the recording medium in the apparatus if the identity determination part determines that the programs are identical.

2. The apparatus as claimed in claim 1, wherein the first identification information has a smaller amount of information than the program recorded in the external medium.

3. The apparatus as claimed in claim 1, wherein the program stored in the recording medium in the apparatus is a copy of the program recorded in the external medium.

4. The apparatus as claimed in claim 1, wherein the program activation part activates the program recorded in the external medium before the recording medium in the apparatus is ready for use.

5. The apparatus as claimed in claim 1, wherein:
a first electronic signature for the program recorded in the external medium is recorded in the external medium as the first identification information; and
the identity determination part determines whether the programs are identical based on the first electronic signature and a second electronic signature for the program stored in the recording medium in the apparatus.

6. The apparatus as claimed in claim 5, wherein:
a decoding key for decoding the first and second electronic signatures is recorded in the external medium; and
the program activation part activates the program recorded in the external medium if a value of the first electronic signature decoded using the decoding key is identical to a message digest of the program recorded in the external medium, and activates the program stored in the recording medium in the apparatus if a value of the second electronic signature decoded using the decoding key is identical to a message digest of the program stored in the recording medium in the apparatus.

7. The apparatus as claimed in claim 6, wherein the decoding key is prevented from being copied into the recording medium in the apparatus.

8. A program activation method in an apparatus capable of activating a program recorded in an external medium for distributing the program, the program activation method comprising the steps of:
(a) determining whether the program recorded in the external medium and a program stored in a recording medium in the apparatus are identical based on first identification information for uniquely identifying the program recorded in the external medium and second identification information for uniquely identifying the program stored in the recording medium in the apparatus; and
(b) activating the program stored in the recording medium in the apparatus if said step (a) determines that the programs are identical.

9. The program activation method as claimed in claim 8, wherein the first identification information has a smaller amount of information than the program recorded in the external medium.

10. The program activation method as claimed in claim 8, wherein the program stored in the recording medium in the apparatus is a copy of the program recorded in the external medium.

11. The program activation method as claimed in claim 8, wherein said step (b) activates the program recorded in the external medium before the recording medium in the apparatus is ready for use.

12. The program activation method as claimed in claim 8, wherein:
a first electronic signature for the program recorded in the external medium is recorded in the external medium as the first identification information; and
said step (a) determines whether the programs are identical based on the first electronic signature and a second electronic signature for the program stored in the recording medium in the apparatus.

13. The program activation method as claimed in claim 12, wherein:
a decoding key for decoding the first and second electronic signatures is recorded in the external medium; and
said step (b) activates the program recorded in the external medium if a value of the first electronic signature decoded using the decoding key is identical to a message digest of the program recorded in the external medium, and activates the program stored in the recording medium in the apparatus if a value of the second electronic signature decoded using the decoding key is identical to a message digest of the program stored in the recording medium in the apparatus.

14. The program activation method as claimed in claim 13, wherein the decoding key is prevented from being copied into the recording medium in the apparatus.
